(19) United States
(12) Patent Application Publication
(10) Pub. No.: US 2008/0223797 A1
(43) Pub. Date: Sep. 18, 2008

(54) FILTERS WITH IMPROVED MEDIA UTILIZATION AND METHODS OF MAKING AND USING SAME

(75) Inventors: ROGER P. REID, CALDWELL, ID (US); BRUCE D. SAASKI, CALDWELL, ID (US)

Correspondence Address: PEDERSEN & COMPANY, PLLC, P.O. BOX 2666, BOISE, ID, 83701, US

(73) Assignee: OMNIPURE FILTER COMPANY, INC., CALDWELL, ID (US)

(21) Appl. No.: 11/858,765

(22) Filed: Sep. 20, 2007

Related U.S. Application Data
(60) Provisional application No. 60/846,162, filed on Sep. 20, 2006.

(51) Int. Cl. B01D 37/00; B01D 39/14; B01D 39/16

(52) U.S. Cl. 210/790; 210/496; 210/291; 210/483; 210/806; 210/294; 210/510.1; 210/502.1

(57) ABSTRACT

Multi-core solid profile filter media blocks include multiple sub-blocks, which may be formed by providing a block with multiple interior cavities extending deep into the block, to allow water to flow deep inside the filter block to access the media of the sub-block (in the case wherein the cavities are at the inlet to the block) or that allows water to be collected from each filtration sub-block (in the case wherein the cavities are at the outlet from the block). One or more indentations/spaces/gaps in the exterior surface of the block also may be provided to separate and extend between portions of the sub-blocks, so that substantially all of the filter media of a sub-block is accessible to fluid for filtration. This way, a filter block may include a large amount of media in a small cartridge or package volume, and the filter block may exhibit good flow distribution and low pressure drop. Sub-blocks of the filter block may be integrally formed together into the filter block, or may be directly connected, for example, preferably without any housing or internals clamping or fastening the sub-blocks together.

This application claims priority of Provisional Application Ser. No. 60/846,162, filed Sep. 20, 2006, the entire disclosure of which is incorporated herein by this reference.

### BACKGROUND OF THE INVENTION

1. Field of the Invention

This invention relates to compositions and shapes for solid profile filters or “filter blocks,” and methods of making or using the same. While the filter blocks and methods may have applications in many process flow schemes, the preferred embodiments of the invention are particularly beneficial in gravity flow or low pressure applications. The preferred filter blocks are adapted to exhibit improved flow distribution and pressure drop, and, therefore, improved flowrates and media utilization.

2. Related Art

Solid profile filters, or “filter blocks,” for water filtration have been commercially-available for many years. Typically, such filter blocks comprise granular activated carbon (GAC) and polymeric binder, with or without various additives such as lead sorbent, and, hence, are often also referred to as “carbon blocks.” The raw materials are extruded or compressed in molds to form hollow, cylindrical or “tubular” blocks. Examples of conventional carbon blocks are given in Heskett U.S. Pat. No. 3,538,020, Degen U.S. Pat. Nos. 4,664,683 and 4,665,050, “Amway” U.S. Pat. No. 4,753,728, and Koslow U.S. Pat. Nos. 5,019,311 and 5,147,722 and 5,189,092. See FIGS. 5A-E for an example of a relatively-thin-walled, hollow, cylindrical carbon block.

The fluid-flow path through these tubular activated carbon blocks is generally radial. In an out-side-in flow scheme, housing structure and internals distribute water to the outer cylindrical surface of the block, and the water flows radially through the cylindrical wall to the hollow axial space at the center axis of the block. From the hollow axial space or perforated tube provided therein, the filtered water flows out of the block at or near either at the bottom end or the top end of the filter block, depending upon how the internals and ports have been designed.

These tubular filter blocks have a single outside diameter “OD” (the outer cylindrical wall) and a single inside diameter “ID” (the inner cylindrical wall), with the two diameters defining a wall thickness. The cylindrical volume, minus the hollow axial space volume, defines the volume of filtering media. These tubular shapes have end surfaces opposing each other axially. These end surfaces are typically sealed to end caps or other housing or internals structure to cause fluid to flow in a radial direction rather than around the end surfaces of the block. The ID, OD, and axial length define the surface areas, volume, and mass of the tubular-shaped activated carbon block. Activated carbon blocks can be varied in outside diameter, inside diameter, and length in order to achieve a specified volume and surface area of media.

The materials used to make radial-flow activated carbon blocks, as shown in the above-referenced patents and as discussed above, are typically carbon particles ranging from 12×30 US mesh to 80×325 US mesh (Koslow states 0.1 to 3,000 micrometers) and thermoplastic or thermo-set binders that are common to the art and disclosed in the referenced patents. Other materials can be blended with the carbon particles and binder particles such as lead- or other metals-reducing adsorbents.

Particle size, wall thickness, surface area, and compression may all be adjusted separately to achieve a desired pressure drop through a filter. Use of smaller carbon particles, increased compression, or thicker walls will generally increase pressure drop and increase contaminant removal. Use of larger carbon particles, less compression, or thinner walls will generally decrease pressure drop and decrease contaminant removal. Larger diameters (OD and ID) for cylindrical blocks will decrease pressure drop by increasing surface area available to the fluid flowing through the block. A large OD carbon block with a small ID will have more pressure drop than the same carbon block with a larger inside ID, as the length of the fluid path through the block is longer.

### Corrugated Filter Sheets for Air Filtration

Clapham, in U.S. Pat. No. 3,721,072, produces a low-pressure air filter by providing a monolithic extended surface filter sheet, in the form of a wave pattern. Each wave of the extended surface consists of a peak and a trough extending along the entire length of the filter body to the outside boundary of the filter. ('072 FIG. 1). Clapham's wave forms are much smaller than the overall dimensions of the filter body, for example, thirteen waves in a single filter body. Also, Clapham's filter body is substantially wider and longer than it is thick, for example, more than 10 times as long (or at least more than 5 times as long) and also more than 10 times as wide (or at least more than 5 times as wide) as the thickness of the filter body. Therefore, the Clapham filter body may be considered a corrugated filter sheet or filter plate. Clapham's sheet-like or plate-like filter body may be placed in a frame, extending around the periphery of the filter body, made of “metal, glass, wood, plastic, paperboard, and the like . . . or bonded carbon integral to the filter.”

Chapman, in U.S. Pat. Nos. 6,322,615 and 6,056,809, discloses corrugated sheets for air filtration, wherein, as in Clapham, the peaks and troughs extend all the way to the outside boundary of the filter, the wave forms are much smaller than the overall dimensions of the filter body, and the filter body may be considered a corrugated sheet or plate. Methods of making this corrugated filter body comprise rolling the filter material between rollers with multiple V-shaped tools forming the peaks and troughs in the extended plate or sheet surface of the filter body.

Gelderland, et al., in U.S. Pat. No. 6,413,303, disclose activated carbon air filters made of layers of corrugated paper sheets coated in carbon and binder. Insley, et al., in U.S. Pat. No. 6,280,824, disclose polymeric film layers comprising filtration media and each having a corrugated shape. Gelderland, et al. and Insley, et al. each teach flow being through the open spaces defined by the corrugates (parallel to the corrugate troughs), rather than through the corrugated plates (ie parallel, rather than transverse, to the plane of each plate).

### Granular Activated Carbon Media for Water Filtration

Granular activated carbon (GAC), without binder and with or without various additives such as lead sorbent, has been used for year in water filtration. The loose, granular activated carbon is typically loaded as a “filter bed” or “carbon bed” in a compartment inside a filter housing. The housing and internals are adapted to contain the otherwise-loose granules in place in the compartment, and to distribute water to the inlet of the bed and collect the water at the outlet of the bed. A bed of GAC, preferably with other granular media or additives such as ion exchange resin, is the conventional media of choice for low pressure or gravity flow applications, because of the relatively low pressure drop through the bed of granules; no binder is present in the carbon bed, and, hence, no binder fills the spaces between the carbon granules to interfere with fluid flow. The interstitial spaces between the granules allow water flow through the bed with good media contact and without the pressure drop that is expected in a compressed, binder-formed block.

One important application for such filter beds of granular activated carbon is the field of disposable filter cartridges used in gravity flow water pitchers, carafes, countertop tanks, and water coolers. These devices are used in many homes, offices, and business wherein batch purification of volumes of about 2-20 liters of water is desired for personal consumption and cooking. Typically, these devices that include filtration capability are filled with tap water from municipal supplies or rural wells, as the user wishes to remove chlorine or other contaminants, or to generally improve the taste and odor of the water. These devices continue to be very popular, especially in view of the emphasis on healthy drinking water and in view of the expense and inconvenience of purchasing bottled water.

These gravity-flow filtration devices typically feature relatively small, disposable and replaceable filters cartridges that are inserted into the device and used for several weeks of normal use. Examples of these devices and/or of filters that are designed for these devices are disclosed in Design U.S. Pat. No. 416,163, Design U.S. Pat. No. 398,184, U.S. Pat. No. 5,873,995, U.S. Pat. No. 6,638,426, and U.S. Pat. No. 6,290,646. The filter cartridges for these devices contain filtration media that entirely or substantially comprises beds of granular media.

Good flow distribution in the filter is of primary concern in gravity flow or low pressure systems, because flow distribution affects filtration effectiveness and the time at which “breakthrough” of contaminates occurs, and, hence, the time at which the filter should be changed out. As these filtration systems typically do not contain any means for monitoring filtration effectiveness or breakthrough, and, at most, have means for measuring total water that has passed through the filter, it is important that good flow distribution be maintained to maximize use of media, and, hence, to maximize the filtration effectiveness for a given volume of filtered water. If channeling occurs at any time during the filter life, the effectiveness of the filter and/or the effective filter capacity is reduced, and the filtered water quality may drop if the filter is not changed out.

Good water flow rate through the filter is also of primary concern in gravity flow or low pressure systems such as a water pitcher, carafe or countertop tank, because this effects how quickly filtered water from a freshly-water-filled device may be used. Typically, these devices are kept in the refrigerator or on a countertop, and so their total volume is designed to be an amount that is reasonable for such spaces and that is a reasonable weight to carry. Users of such devices typically do not want to wait a long time for the filtered water. Therefore, reasonable flow rate through the filter is important for customer satisfaction and to gain a competitive edge in the marketplace. As most of these water filtration devices typically utilize only gravity to force the water through the filters, achieving adequate flowrate of water through the filter is problematic, especially in view of the goal of effective contaminant removal and long filter life. The goal of low pressure drop for high flowrates would drive the design toward short (shallow) granular filter media beds, but the goal of effective contaminant removal and long life without breakthrough would drive the design to in the opposite direction, toward long (deep) granular filter media beds. Further, achieving adequate flowrate is also problematic because the carbon-based granular media that are used in the filters in question tend to be slightly hydrophobic. Therefore, while excellent water-media contact is needed for good flow distribution and good flow rates, the media actually tends to resist wetting by the water it is intended to filter.

Therefore, conventional filters for water pitcher devices have typically included granular media beds about 2-6 inches deep. Further, important procedures in the installation of a filter into one of these water pitcher devices are the pre-rinse and the pre-wet steps recommended by manufacturers of the devices and the filters. These procedures involve rinsing the filter and then soaking the fresh filter in water for several minutes prior to inserting the filter into the device. These procedures are explained by the manufacturers as steps that remove carbon fines that may reside in the fresh filter, and that wet the granular or particulate carbon media to achieve better flow distribution and flow rates after the filter cartridge is installed in the device.

The inventors believe that there is room for improvement in filters used for gravity flow water filtration devices, such as water pitchers, carafes, and countertop tanks, and in the filters that are used for low-pressure systems (such as 30 psi or less). The inventors believe that embodiments of the invented solid profile filters or “filter blocks” may be effective for said gravity flow or low-pressure systems, and/or for a wide variety of applications other than gravity-flow and low-pressure systems. Preferred embodiments of the invented apparatus and methods may satisfy the needs of many filtration applications and flow schemes by providing filters of improved flow distribution, flow rate, contaminant reduction/removal, performance consistency, and/or durability.

### SUMMARY OF THE INVENTION

In a first group of embodiments, the invention comprises a solid profile filter block comprising multiple sub-blocks, each of said sub-blocks comprising filter media walls surrounding and defining a cavity for receiving fluid, and each of said sub-blocks being connected to at least one other of said sub-blocks by filter media of which the filter block is made. The invention may also comprise methods of making and/or using said solid profile filter block.

In a second group of embodiments, the invention comprises a solid profile filter block comprising multiple sub-blocks, each of said sub-blocks comprising filter media walls surrounding and defining a cavity for receiving fluid, and each of said sub-blocks being connected to at least one other of said sub-blocks by adhesive, polymeric binder, melting and re-solidification of binder already present in said sub-blocks, and/or other direct attachment of a given sub-block to another sub-block. Direct attachment in this second group of embodiments does not include clamping, engaging, or fastening a given sub-block to another sub-block by filter housing components, clamps, or fasteners.

In each of the first and second groups of embodiments described above, the multiple-sub-block filter block may comprise a main body of filter media with multiple cavities provided therein (whether or not the main body also comprises external indentations/gaps/spaces that are described later in this disclosure). The main body of the filter block, therefore, may be described also as a multi-core filter block, wherein the main body has been “cored” in multiple locations by removal of material or molding of the main body to have the cavities.

In each of the first and second groups of embodiments described above, the preferred filter blocks each comprise multiple sub-blocks may be formed by providing multiple internal cavities in a filter block and also at least one external indentation, wherein each of said internal cavities and said external indentation extends deep into the block. The cavities will be understood to be extremely large compared to interstitial voids of the media, and large compared to imperfections or other irregularities in the main body of the filter block. As described later in this disclosure, the indentation(s) for molded filter blocks are frequently in the bottom of the filter block for easier removal from the mold, but indentations (including gaps, spaced, or recesses) may also be in other portions/surfaces of the filter block.

Preferably, the indentation(s) extend(s) along at least ⅓ of the adjacent sub-block, and, more preferably, ⅓ up to ⅞ along adjacent sub-block. Thus, when considering a filter block wherein the sub-blocks extend along substantially the entire filter block, it is preferred that at least one indentation extend into the filter block to a depth equal to about ⅓-⅞ (and more preferably ½-⅞) of the relevant filter block dimension. For example, if the indentation extends axially into the filter block, it is preferred that the indentation depth be equal to ⅓-⅞ of the axial length of the filter block. For example, if the indentation extends radially into the filter block, it is preferred that the indentation depth be equal to ⅓-⅞ of the diameter of the filter block. By extending deep into the block, said cavities and indentation(s) may provide access deep in the block for fluids flowing into or out of the filter block. In an inside-out flow scheme, the multiple internal cavities allow inlet fluid to flow deep inside the filter block to access the media of the sub-blocks, and said at least one external indentation allows outlet fluid to be collected from the sub-blocks in region(s) between the sub-blocks. In an outside-in flow scheme, said at least one external indentation allows inlet water to reach each sub-block from region(s) between the sub-blocks, and the multiple internal cavities allow outlet fluid to be collected from the sub-blocks deep inside the filter block. The internal cavities may comprise D-shaped, circular, triangular, polygonal, or other shapes in cross-section or in end-view. Said at least one external indentation may comprise one or more slots, holes, cross-shaped slots, or other recesses, gaps, or spaces.

Said at least one external indentation is provided in the outer surface of the block to separate portions of the sub-blocks to provide a space between exterior surfaces of said portions of the sub-blocks (these particular exterior surfaces being those that “face” the exterior indentation) for fluid access out of or into said sub-blocks from regions at or near the central axis of the filter block or other regions of the sub-blocks not at the outer perimeter/circumference of the filter block. This way, all or substantially all of the filter media of each sub-block is accessible to fluid for filtration, rather than solely the media near the outer perimeter/circumference of the filter block.

Said first group of embodiments, including those which comprise both multiple internal cavities and at least one external indentation, are preferably made in a molding process or other process that forms multiple of the sub-blocks, or preferably all of the sub-blocks, at the same time. However, such molding or otherwise forming many of these preferred embodiments poses particular problems due to the preferred sub-block structure and the deep penetration of the cavities and indentation(s) into the filter block. Unless special adaptation is made in many embodiments, blemishes, holes, torn or destroyed sub-block walls, and/or other imperfections in the block may occur during separation of the filter block and the mold/tools. As a filter block with uniform flow distribution is an important object of these embodiments, such imperfections are usually not acceptable. Therefore, the inventors have provided adaptations in the block shape, to allow for proper removal of the block from the mold or other forming tools. The adaptations may include orientation of the sub-blocks to be “clustered” around a central axis, shape and diameter of the cavities and indentation(s) being adapted to minimize thin portions extending transverse to the direction in which the filter block is removed from the mold, and tapering/slanting of the surfaces of the block, including the outer perimeter surfaces, and/or the internal cavity surfaces, and/or the external indentation surfaces. These adaptations allow many embodiments of the filter blocks, including all of its sub-blocks, to be made in a single mold at one time. These adaptations allow various embodiments to achieve the objectives of a relatively large volume of media in a small “package” (small housing, and small “footprint” inside a water filtration pitcher or other device), with a low pressure drop, good flow distribution, coupled with durability and performance consistency.

In said second group of embodiments, including those which comprise both multiple internal cavities and at least one external indentation, some or all of the sub-blocks may be molded or formed in different molds, at different times, and/or by different processes, followed by direction attachment of the sub-blocks to one or more adjacent sub-blocks. By using direct attachment, rather than housing components, clamps, or fasteners, to attach sub-blocks to each other, there is little or no material between the sub-blocks (for example, only glue, adhesive, and/or binder). This direct attachment, because space between the sub-blocks is not being taken up by housing components, clamps, or fasteners, also allow various embodiments to achieve the objectives of a relatively large volume of media in a small “package” (small housing, and small “footprint” inside a water filtration pitcher or other device), with a low pressure drop, good flow distribution, coupled with durability and performance consistency.

The invented solid profile filter blocks may feature many different overall filter block sizes and shapes, and the multiple sub-blocks of the filter block may feature many different sub-block sizes and shapes. The preferred filter blocks may be considered three-dimensional rather than sheet-like, plate-like, or generally two-dimensional. Also, the preferred blocks are of dimensions such that they are not to be considered “pleated” or “corrugated” sheets or plates.

The filter blocks of the preferred embodiments comprise activated carbon particles/granules, binder particles, and optional additives, that are formed into said multiple sub-blocks. The preferred optional additives are metals removal additives, for example, lead sorbent/scavengers such as Alusil™ or ATS™, or arsenic removal additives. Some embodiments of the invented filters may be effective in removing both soluble and/or particulate lead from water. Optionally, instead of, or in addition to, carbon particles/granules, activated carbon fibers may be used with binder to form the solid profile. Also, other filtration or treatment media may be used, in place of or in addition to, activated carbon granules or fibers.

The opening of each internal cavity may be located at or near a common first axial end, and the sub-blocks preferably extend from that common end generally parallel to each other, and preferably clustered around, or arranged symmetrically around, the center axis of the block rather than on a single plane. In such embodiments, inlet or out fluid (depending on whether the application is an inside-out or an outside-in flow scheme) would enter or leave said multiple cavities at the same or about the same time at or near the time of entering or exiting the filter block. One or more external indentations may be located at or near said central axis of the block, at the opposite, second axial end, for separating the sub-blocks at or near said second axial end. Such configurations may be provided, for example, by molding or otherwise forming said sub-blocks in a single, unitary filter block, or by direct attachment of the sub-blocks into a single filter block.

Alternatively, other embodiments may include a single internal cavity that, farther along the axial length of the filter block, branches into multiple cavities. In such embodiments, an external indentation will typically be provided in the region of the filter block comprising the branching into multiple cavities. Such filter block embodiments may be described as comprising multiple sub-blocks in a portion of the filter block, rather than the filter block being formed entirely or substantially entirely of said sub-blocks. In such embodiments, inlet or outlet fluid (depending on whether the application is an inside-out or an outside-in flow scheme) would enter or leave said multiple cavities at a time different from the fluid entering or leaving the filter block, as the residence time in the filter block would comprise a period of the fluid residing in the single cavity region of the filter block.

While other sub-block and internal cavity arrangements may be included in the invention, it is preferred that there is some symmetry along the flow path so that fluid entering one of the sub-blocks will be filtered/treated the same or very similarly to fluid entering others of the sub-blocks. Therefore, it is preferred that the filter block comprise a plurality of sub-blocks that are symmetrically disposed relative to an inlet port or inlet distributor for parallel flow through the sub-blocks, and it is preferred that the sub-blocks comprise the same or similar amounts and types of media.

The above shapes and forms, and other shapes and forms still within the scope of the invention, will become apparent to the reader after review of this Description, the drawings, and the claims.

### BRIEF DESCRIPTION OF THE DRAWINGS

FIGS. 1A-F are a perspective view, a front view, a side view, a top view, a bottom view, and an axial cross-sectional view (along the line 1F-1F in FIG. 1D), respectively, of one embodiment of the invented multi-core block.

FIG. 1G is a perspective view of the embodiment of FIGS. 1A-1F, with a bead/ring of adhesive added for sealing an end of the filter block to a housing structure.

FIGS. 1H-J are a side view, a front view and a perspective view of the embodiment of FIGS. 1A-G, with hidden structure shown in dashed lines.

FIGS. 1K and L are perspective cross-sectional views of the embodiment of FIGS. 1A-J, taken transverse to the plane separating the two sub-blocks of the filter block. FIG. 1L includes hidden structure in dashed lines.

FIGS. 1M and N are perspective cross-sectional views of the embodiment of FIGS. 1A-L, taken along the plane that separates the two sub-blocks of the filter block. FIG. 1N includes hidden structure in dashed lines.

FIGS. 2A-F are a perspective view, a front view, a side view, a top view, a bottom view, and an axial cross-sectional view, respectively, of another embodiment of the invented multi-core block.

FIGS. 3A-F are a perspective view, an axial cross-sectional view, a top view, a bottom view, a front view, and a side view, respectively, of yet another embodiment of the invented multi-core block.

FIGS. 4A-E are a perspective view, a front view, a top view, a bottom view, and an axial cross-sectional view, respectively, of yet another embodiment of the invented multi-core block.

FIGS. 5A-E are two opposing side views, a top view, a bottom view, and an axial cross-sectional view of a prior art cylindrical activated carbon filter block.

FIGS. 6A-E are a perspective view, a side view, top and bottom views, and a cross-sectional view of a cup-shaped filter block.

FIGS. 7A and B are schematic view of an embodiment of the invented filter block contained in a housing, wherein FIG. 7A is illustrates one embodiment of an inside-out flow scheme and FIG. 7B illustrates one embodiment on an outside-in flow scheme. These schematics comprise flow through the cartridge generally from top to bottom as might be used in a gravity flow scenario, but, as noted elsewhere, other cartridges orientations and flow directions may be used.

FIGS. 8A-E are a front view; a perspective, transverse cross-sectional view (transverse to the plane between the sub-blocks); a perspective cross-sectional view (on the plane between the sub-blocks); a bottom view; and a perspective, cross-sectional view taken diagonally through the filter block, respectively, of an alternate embodiment of the invented filter block. Theses figures portray one embodiment of a brace or partition provided in the filter block external indentation for strengthening/reinforcing the filter block.

FIGS. 9A-D are a perspective view, a top view, a first perspective cross-sectional view and a second perspective cross-sectional view, respectively, of another embodiment of the invented filter block, wherein the block comprises a single cavity at its first end, which single cavity opens into (communicates with) two cavities about midway along its length, and wherein this block has no glue recess at its first end but rather a flat end surface for sealing to a housing or internals structure. The cross-sectional view in FIG. 9C is taken along a transverse plane (perpendicular to the plane that separates the two sub-blocks) and the view in FIG. 9D is taken on said plane that separates the sub-blocks.

FIGS. 10A and B G are a perspective and a perspective cross-sectional view, respectively, of another embodiment of the invented filter block that is similar to the embodiment of FIGS. 9A-D except that this block has a glue recess encircling its first end.

FIG. 11A-C are a perspective, a perspective transverse (to the plane between the sub-blocks) cross-sectional view, and a perspective cross-sectional view along the plane between the sub-blocks, respectively.

FIGS. 12A and B illustrate alternative embodiments of the invented multiple-sub-block filter blocks comprising indentations into the filter block, wherein the indentations extend into sides of the filter block and not into the bottom of the filter block. Thus, the sub-blocks of these filters are attached/connected, rather than being separated/spaced at their bottom ends.

### DESCRIPTION OF THE PREFERRED EMBODIMENTS

Objects of the preferred embodiments include maximizing the volume of a solid profile filtration media in a given cartridge, housing, or “package” total volume, while providing good contact between the fluid being filtered/treated and said solid profile media and providing low pressure drop, for high contaminant reduction and good flow rates. Embodiments of the invented multiple-sub-block solid profile filter blocks achieve some or all of these objects.

The preferred filter blocks may be considered three-dimensional filters, rather than being sheet or panel filters. Multiple internal cavities and preferably one or more external indentations allow water or other fluid to flow deep into/inside the three-dimensional filter block, to preferably access all or substantially all of the media of the each sub-block. The indentation(s), therefore, tend to extend into the filter block at or near a central region of the filter block, to provide fluid access space between the sub-blocks. The indentation(s) may take the form of slots, holes, recesses, or other spaces or gaps provided between the sub-blocks along a substantial portion of the sub-blocks. By providing these structures and adaptations, the preferred embodiments prevent there being significant unused zone(s) of media between the internal cavities, wherein such zone(s) of media would be “unused” because they would have no effective fluid inlet or outlet and would take up space within a filter cartridge without contributing significant filtration/treatment capability. This way, substantially all of the filter media of a sub-block is accessible to fluid for filtration/treatment, rather than just the media near the outer perimeter/circumference of the block.

Referring to the Figures, there are shown multiple, but not the only, embodiments of the invented solid profile filter blocks. Embodiments are portrayed wherein the opening of each cavity is located at a common first axial end, and the sub-blocks extend from that common end generally parallel to each other but preferably clustered around, or arranged symmetrically around, the center axis of the block rather than on a single plane. Also, embodiments are portrayed wherein a single cavity branches, farther along the axial length of the filter block, into multiple cavities. The opening of a single cavity may be located at a first axial end of the block, with the multiple cavities beginning at some point or points along the length of the block, and the closed ends (or capped ends) of the multiple cavities typically lie at or near the second axial end opposite the single cavity opening. One or more external indentations, gaps, or spaces, may be located, for example, at or near said central axis of the block at said second end, for separating the sub-blocks at or near said second end. In each of these types of multiple-sub-block configurations, it may be noted that the internal cavities comprise a closed/capped end, so that fluid flow may not flow through any of said cavities to exit the filter block without flowing through at least a portion of the filtration/treatment media, that is, without flowing through a wall of media. The closing or capping may comprise, for example, closing an end of a cavity with a media wall or with a portion of the filter cartridge housing or with filter internals such as a plate or other sealing member.

Alternatively, although not portrayed in the drawings, the inventors envision that embodiments of the invention filter blocks with a first set of multiple cavities at one end of the block, branching into different numbers or shapes of multiple cavities of a second set of said cavities generally midway along the length of the block. The openings of the first set of multiple cavities may be located at a first axial end of the filter and the closed or capped ends of the second set of cavities is typically at the opposite end of the filter block. Thus, embodiments of the invention may include significant branching of internal cavities, preferably with external indentations providing space/gaps between the sub-blocks at least at said second end of the filter block between the sub-blocks of the second set of cavities for separating the sub-blocks at or near the second end.

Thus, one may see from the above examples of internal cavities, that the multiple-sub-block form of the preferred embodiments may include, for example: a filter block that has multiple-sub-block filtration units extending all along the filter block length; a filter block with a first axial end region that comprises a single filtration unit (which itself may be considered a sub-block), transitioning to a middle or second axial end region comprising multiple sub-blocks; or a filter block with a first axial end region comprising multiple sub-blocks transitioning to middle or second axial end region comprising different multiple sub-blocks. The inventors envision that the preferred filters will have as few as two sub-blocks up to about 10 sub-blocks, but that it is more likely that filters of 2-5 sub-blocks will be effective in terms of quality control during manufacture and durability of the product. In each case, the preferred sub-blocks are integral with each other and/or directly attached to each other, so that neither housing nor casing components, nor internal filter cartridge components (such as are typically made of plastic or metal), nor clamps, are necessary to hold the sub-blocks together and, therefore, so that preferably none of these housing/casing/internals components/clamps are present between the sub-blocks. This way, preferably none of said housing/casing/internals components/clamps take up space inside the filter block.

The overall shape of the invented filter block may or may not be cylindrical (may or may not be round in cross-section and/or end-view) and, instead may be square, oval, triangular, or other shapes in cross-section and/or in end-view. The preferred filter blocks may be considered three-dimensional solid profiles, and may be described as having three dimensions that are on the same order of magnitude and/or may be described as being substantially non-planar or substantially non-sheet-like. For example, the preferred embodiments may be dimensioned to have an axial length within the range of ⅓-10 times the diameter of the filter block (more preferably ⅓-5 times the diameter, and most preferably 1-5 times the diameter). For these calculations, because many of the blocks are tapered in diameter, the largest diameter of the block, may be used. In non-cylindrical blocks, the axial length is preferably within the range of ⅓-10 times the width (more preferably ⅓-5 times the width, and most preferably, 1-5 times), and within the range of ⅓-10 times the depth (more preferably ⅓-5 times the depth, and most preferably, 1-5 times the depth).

Also, the shape of each of the filtration sub-blocks may be cylindrical, conical, or square, oval, triangular, or other shapes in cross-section and/or end-view. Each sub-block comprises a media wall that preferably surrounds at least four sides, and preferably five sides, of a cavity, which may also be called an internal hollow space in the filter block that may be placed in fluid communication with a fluid inlet to the filter cartridge or a fluid outlet from the filter cartridge. In other words, multiple media walls connect to or are integral with each other, so that each cavity is surrounded on four sides and, optionally, at one of its ends by the media wall. The media walls defining the sub-blocks preferably do not connect to each other all the way to the end of the block, but are, instead, preferably spaced apart along at least a portion of their lengths by the external indentation(s). Said indentation(s) may be provided by slots, holes, or other shapes of external indents, recesses, spaces or gaps between significant portions of the sub-blocks, including those purposely made in the molding process or other methods of making an integral filter block, and including those purposely left between the sub-blocks during direct attachment of sub-blocks to each other.

The preferred configurations include at least one end of each cavity being closed, preferably by a media wall that extends radially. This radial filter wall has a thickness sufficient to close, and, in effect, to “seal” each cavity, and/or to properly filter any fluid that passes through it. With the radial filter wall at least as thick as the axial filter walls, the fluid will tend to flow radially through the generally-axial filter walls, but, if the fluid does flow axially through the radial filter wall, the fluid will be appropriately filtered. In most embodiments, the cavity walls that create the inside surface areas do not protrude through the entire length of the block shape and so the radial filter wall, instead of a housing or internals plate, cap, or seal, serves to close one end of the cavities. In less-preferred embodiments wherein the cavities protrude through the entire length of the block shape, an additional sealing plate, cap, or other seal would be needed to maintain radial flow through the axial filter walls.

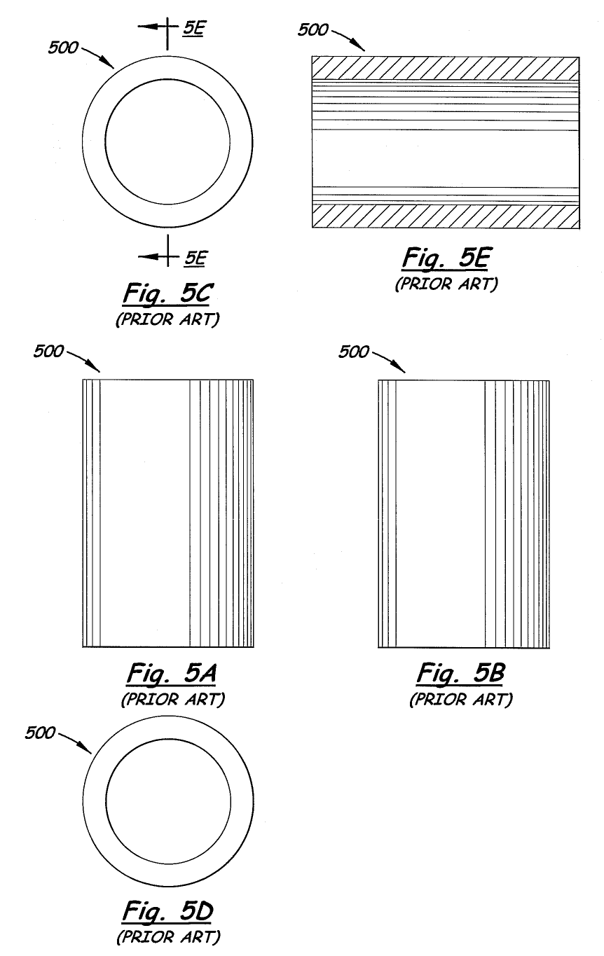

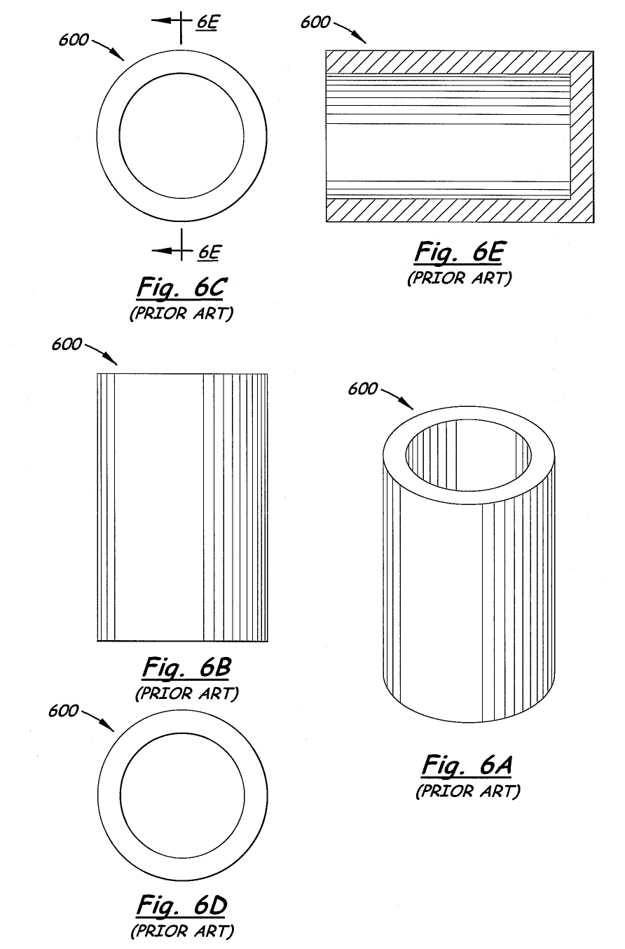

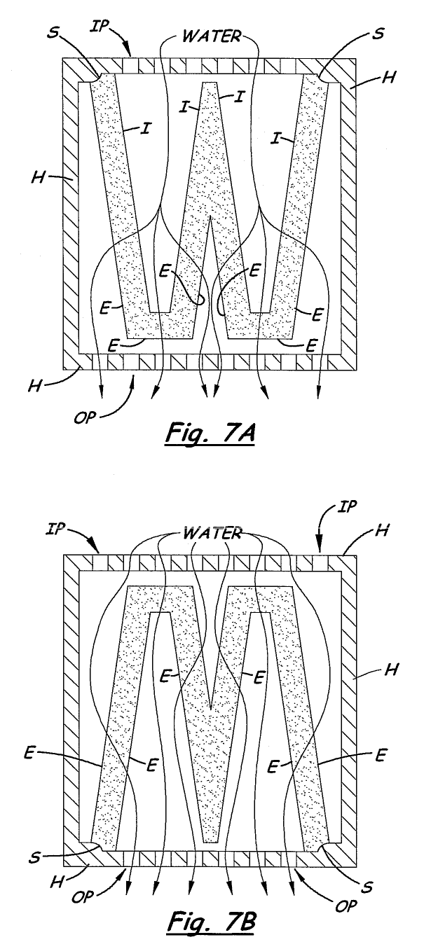

Referring specifically to Figures, there are shown several, but not the only, embodiments of the invented multiple-sub-block filter block, which may be compared to the prior art hollow, cylindrical filter block in FIGS. 5A-E and the cup-shaped filter block in FIGS. 6A-E.

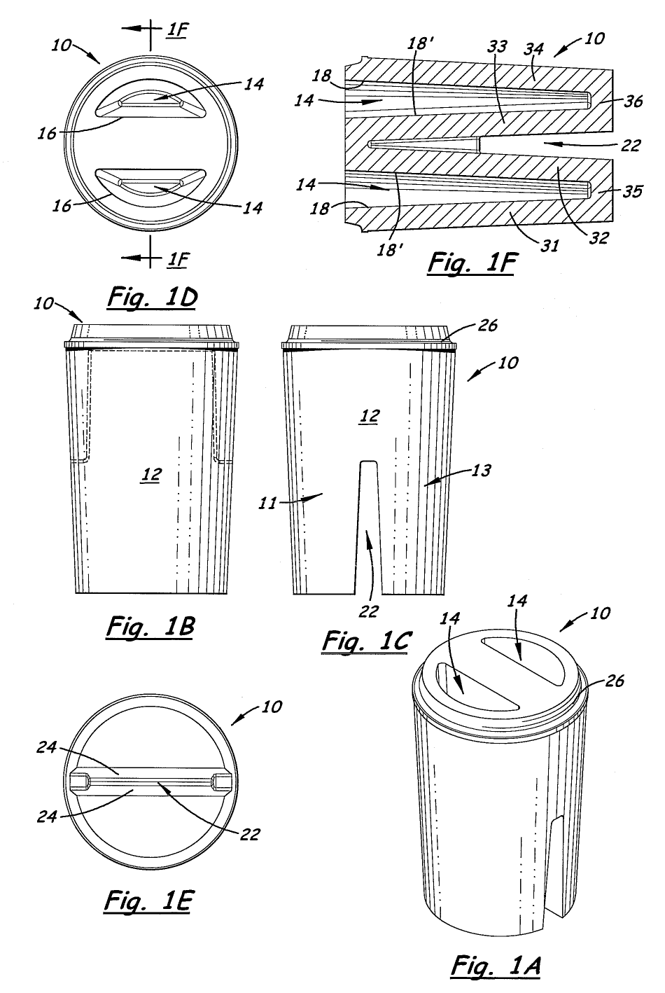

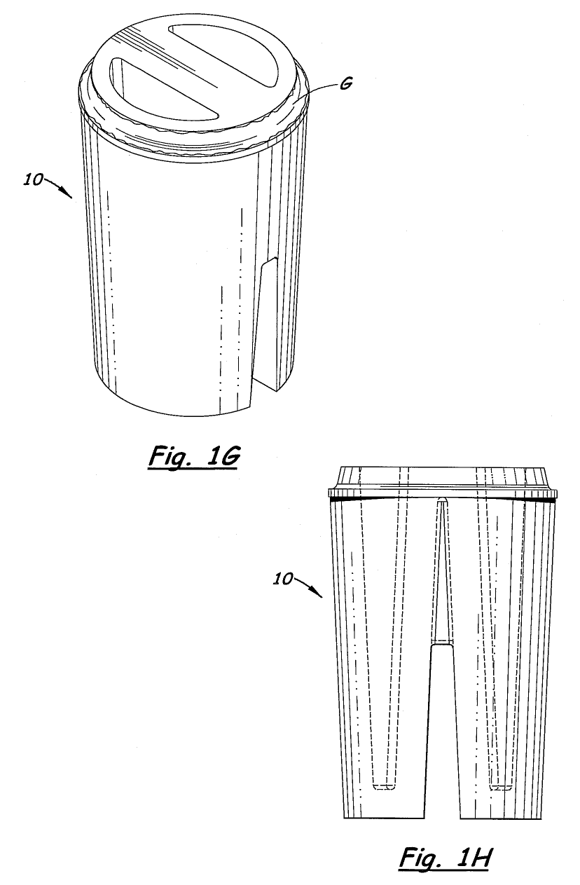

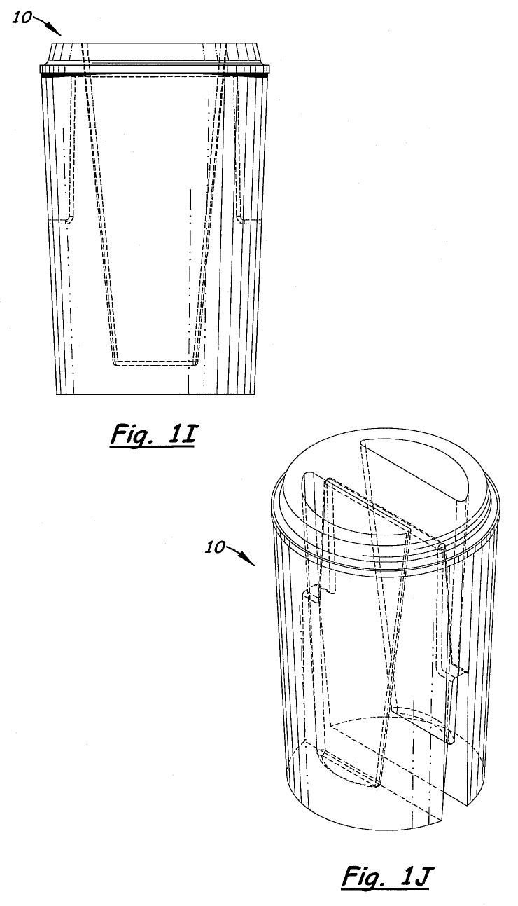

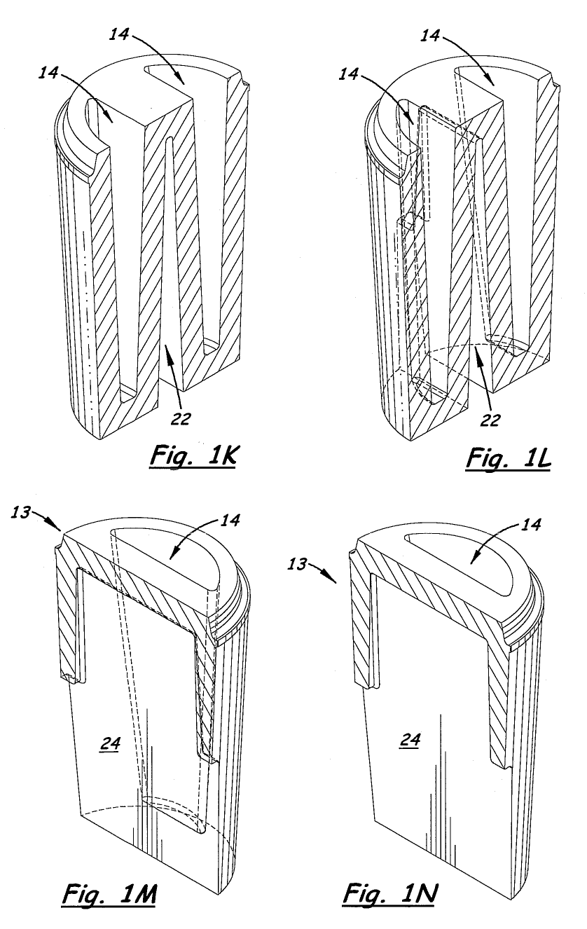

The filter block 10 in FIGS. 1A-N may be described as a “two-sub-block” filter block, wherein each of the two sub-blocks 11, 13 may be called a generally semi-cylindrical or a generally D-shaped sub-block. Filter block 10 is generally cylindrical, preferably with a tapered outer axial surface 12 having an outer diameter that tapers from larger at the top end to smaller at the bottom end, and having two generally D-shaped internal cavities 14 extending axially in the block. The cavities 14 have D-shaped openings 16, both at the top end, with the cavity preferably maintaining generally a D-shape throughout the length of the cavity, but with the size of the cross-sectional D-shape becoming smaller toward the bottom end of the cavity in view of the preferred slanted inner walls or cavity surfaces 18. Preferably both “sides” of the cavity wall (18, 18′) are slanted/tapered, to ease removal from the mold. An external indentation in the form of slot 22 extends into the bottom external surface of the block (extending about half way along the length of the filter block 10), to create a slot surface portion 24 of the external surface of the block, further separating the two sub-blocks and providing access for water in between the sub-blocks (either water entering the block from the outside of the block (outside-in flow) or water exiting the block (inside-out flow). As shown to best advantage in the cross-sectional view, it may be noted in this embodiment and others that are described below, that the external indentation(s) extend(s) into the filter body in between sub-blocks and, therefore, also may be described as extending into the filter body between the cavities of the sub-blocks.

A lip, depression, or other ring structure 26 preferably surrounds the top end of the block, as a recess for receiving adhesive (G) for sealing the top end of the filter to a cartridge housing component, thus, preventing water from bypassing around the top end of the filter. The block structure, combined with the adhesive or other seal, may eliminate the need to place a plastic plate at the top end of the filter that is separate from the cartridge housing. This way, water flow may be controlled, for example, in the case of inside-out flow, the water enters only at the cavities openings 16 and flows generally radially through preferably all the generally axial block walls (illustrated as 31, 32, 33, 34 in FIG. 1F) and typically also flows generally axially through radial walls (shown as 35 and 36 in FIG. 1F). In the case of outside-in flow, the water enters only at the outer surface (12 and 24) and flows generally radially through the axial walls (31, 32, 33, 34) inward to the cavities 14 and typically may also flow axially through radial walls 35, 36 into the cavities 14.

The block in FIGS. 1A-N, in its preferred (but not the only) version and size, has a major outside diameter of about 1.95 inches, a minimum wall thickness of about 0.26 inches, and a length of about 3 inches. This results in about 5.41 cubic inches of volume and a surface area substantially increased by the walls 18, 18′ of the interior cavities 14 and walls 24 of exterior cavity slot 22.

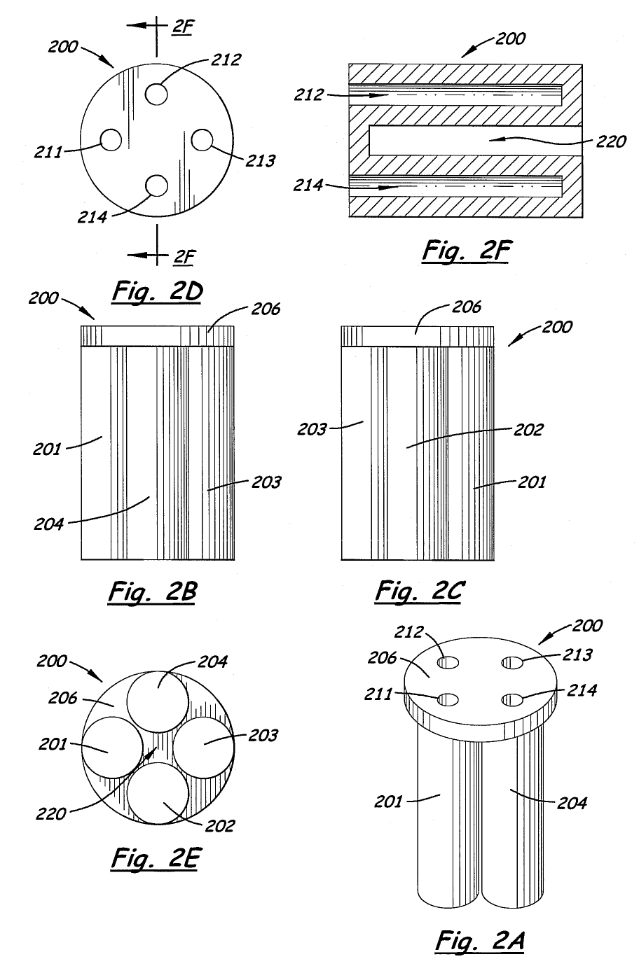

The filter block 200 of FIGS. 2A-F comprises multiple generally cylindrical sub-blocks 201, 202, 203, 204 that are connected together by a top plate 206 of media with openings 208 into the cavities 211, 212, 213, 214. In sub-block embodiments that are integrally formed, top plate 206 is not a separate structure, but is instead integral with the multiple sub-blocks. In direct attachment embodiments, the top plate 206 and some or all of the sub-blocks may be formed separately and then directly attached to other by adhesive or other direct attachment means as discussed earlier in this disclosure. Thus, in cases of direct attachment of each of said sub-blocks to at least one other of said sub-blocks, there may be a seam or interface between said sub-block and the at least one other sub-block that comprises a thin layer or adhesive, glue, or melted and re-solidified binder. This thin layer would be at the seam/interface portrayed in FIGS. 2A-F between top plate 206 and the sub-blocks 201, 202, 203, 204, for example.

In cross-section, as viewed along line 2F-2F, one may see just two of the sub-blocks 202, 204 and just two of the cavities 212, 214. The block 200 comprises an opening/space between the sub-blocks (channel 220, an example of an external indentation) that allows water access between the sub-blocks, preferably either to reach the external surface of the sub-block portions “facing” each other for flow outside-in even in the area between the sub-blocks, or for water collection between the sub-blocks after inside-out flow out of the sub-blocks.

Block 200 in its preferred (but not the only) version and size has a major outside diameter of about 1.95″, a length of about 3″, a minimum wall thickness of about 0.260″, a volume of about 5.6 cubic inches, and a surface area substantially increased by the interior cavities 211, 212, 213, 214, and channel 220.

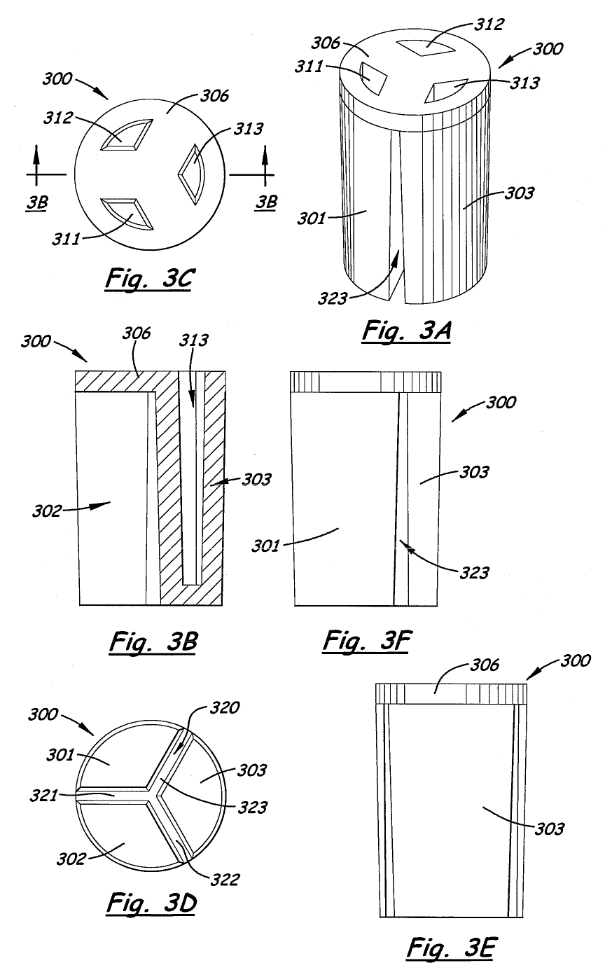

Block 300 in FIGS. 3A-F comprises three sub-blocks 301, 302, 303 (each being generally a third of a circle in cross-section) of media that are connected together at their tops at top portion 306 having openings 308 into the cavities 311, 312, 313. As discussed above for block 200, the top portion 306 may be integral with the sub-blocks and/or may be directly attached to the sub-blocks. In cross-section, as viewed along line 3B-3B, one sees just one of the sub-blocks 303 in cross-section, one sub-block 302 in the background, and just one of the cavities 313. Again, there is an opening/space between the sub-blocks (in this embodiment, slot 320 with slot arms 321, 322, 323, which are examples of external indentations) that allows water access between the sub-blocks, preferably either to reach the outer surface of the sub-block portions “facing” each other for flow outside-in even in the area between the sub-blocks, or for water collection between the blocks after inside-out flow out of the sub-blocks.

Block 300 in its preferred (but not only) version and size has a major outside diameter of about 1.95″, a length of about 3″, and a minimum wall thickness of about 0.260″, a volume of about 6.31 cubic inches, and a surface area substantially increased by interior cavities 311, 312, 313, and exterior cavity 320 (slot portions 321, 322, 323).

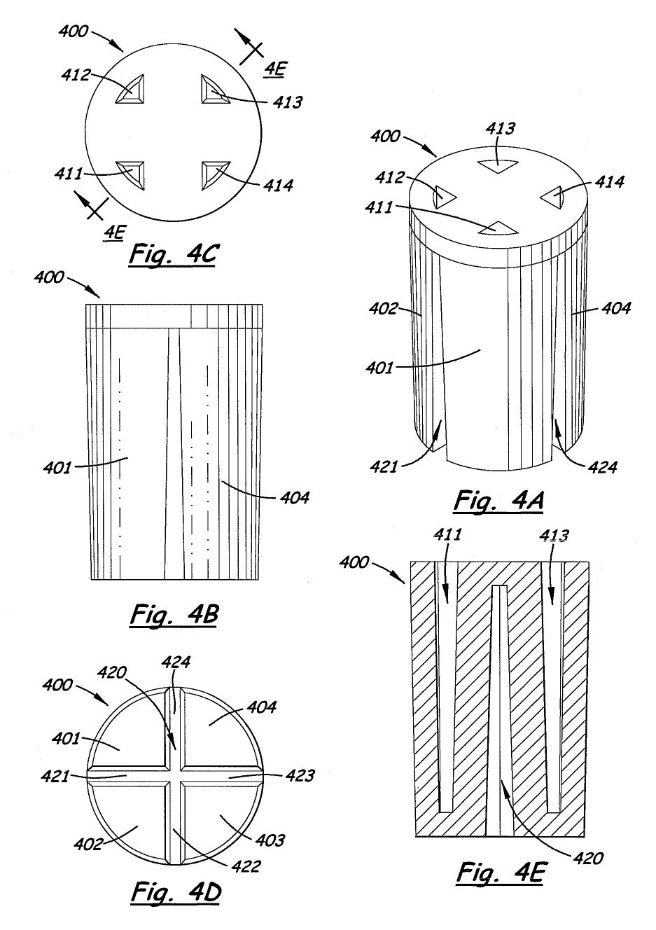

Block 400 in FIGS. 4A-E comprises four sub-blocks 401, 402, 403, 404 (each being generally a fourth of a circle in cross-section) of media that are connected together at their tops at top portion 406 having openings 408 into the cavities 411, 412, 413, 414. As discussed above for blocks 200 and 300, the top portion 406 may be integral with the sub-blocks and/or may be directly attached to the sub-blocks. In cross-section, as viewed along line 4E-4E, one may see just two of the sub-blocks 401, 403, and just two of the cavities 411, 413. Again, there is an opening/space between the sub-blocks (in this embodiment, slot 420 with slot arms 421, 422, 423, 424) that allows water access between the sub-blocks, preferably either to reach the outer surface of the sub-block portions “facing” each other for flow outside-in even in the area between the sub-blocks, or for water collection between the blocks after inside-out flow out of the sub-blocks.

Block 400 in its preferred (but not only) version and size has a major outside diameter of 1.95″, a length of 3″, and a minimum wall thickness of 0.260″, and a volume of 6.42 cubic inches, and a surface area substantially increased by interior cavities 411, 412, 413, and 414, and exterior cavity 420 (slot arms 421, 422, 423, 424).

FIGS. 5A-E show an activated carbon block 500 using prior art cylindrical structure. One may note that, in this cylindrical block 500, the interior surface substantially matches the exterior surface in shape; that is, the inner surface is a cylinder and the outer surface is a cylinder. The block 500 does not have additional cavities, cavity surfaces or indentations, either on the interior or the exterior, to add to the fluid-accessible surface area.

FIGS. 6A-E illustrate that, one may add a “bottom” to the cylindrical block, making a standard single-cup filter block 600 having an axial cylindrical wall and a radial bottom wall. One may note that, in this cup-shaped block 600, the interior surface substantially matches the exterior surface; that is, the inner surface is a cup-shape and the outer surface is a cup-shape. The block 600 does not have additional cavities, cavity surfaces, or indentations, either on the interior or the exterior, to add to the fluid-accessible surface area.

The preferred filter blocks of the invention, on the other hand, have additional cavities, cavity surfaces, and indentations/spaces/gaps that increase fluid-accessible surface area. The multiple-sub-block filter block shapes according to many embodiments of the invention will increase inlet or outlet surface area (and preferably both) for a given volume of activated carbon material and for a given filter cartridge volume, housing volume, or “package” volume. An important design feature, for a filter cartridge in a gravity-flow water pitcher or tank for example, is to minimize the total space that a cartridge or filter housing takes up (also called the filter “package” volume) inside the pitcher or tank. Therefore, embodiments of the invention that minimize the package volume, while providing excellent filtration performance and life and good flow-rates, will be beneficial for said pitcher or tank applications.

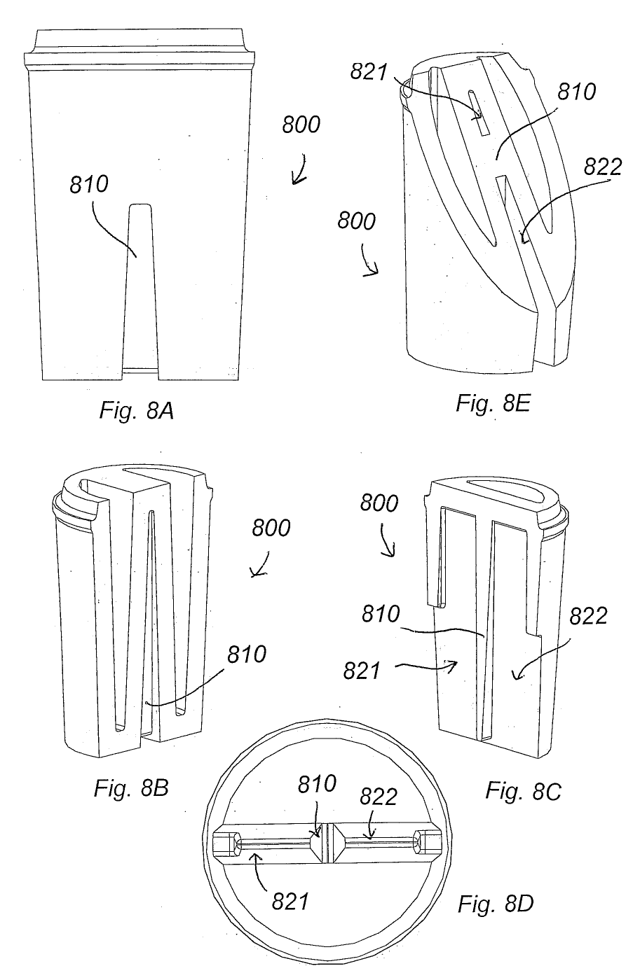

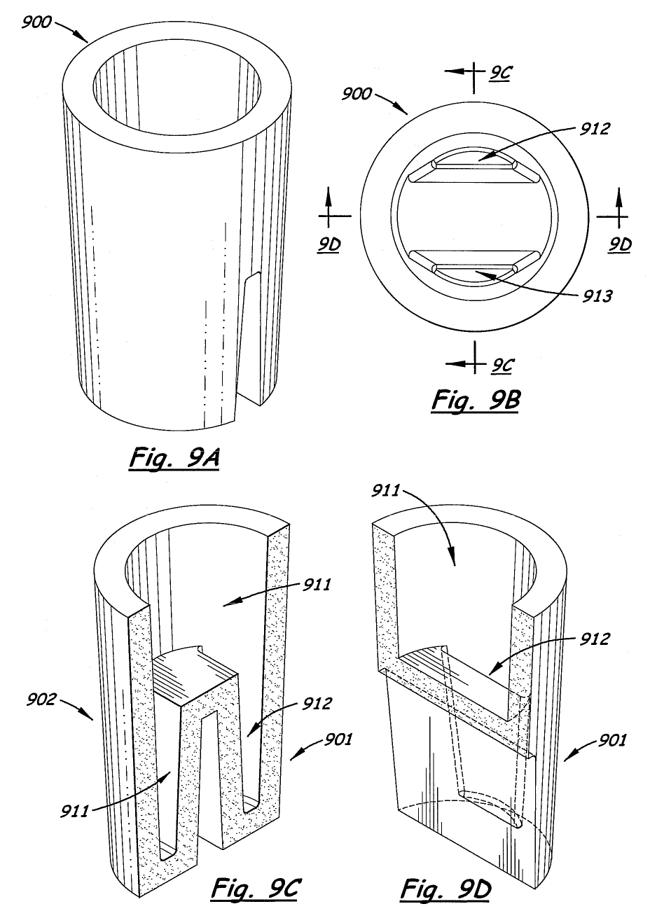

FIGS. 7A and B schematically illustrate inside-out flow schemes, and outside-out flow schemes, respectively, for one embodiment of a multiple-sub-block filter provided in a filter cartridge housing H. In each schematic, the surfaces marked “I” are those that are considered portions of the internal surface of the filter block (or “the internal surface area” or “cavity surface area”). The surfaces marked “E” are those that are considered portions of the exterior surface of the filter block; note that this includes the surface of the indentation and it is in fluid communication with the other portions of the external surface. The surfaces marked “S” are those that are sealed against housing or other sealing structure to control fluid flow and prevent bypass. Note that the fluid inlet distribution and fluid outlet are schematically drawn, including many inlet holes “IP” and many outlet holes “OP,” as the inlet and outlet distributors/ports may be designed in various ways as will be understood by those of skill in the art.

FIGS. 8A-E portray one, but not the only, embodiment of a filter block 800 that includes a brace 822 or partition dividing or extending into the indentation space. Filter block 800 is similar to filter block 10, in FIGS. 1A-M, except that the brace 810 extend between and connects the two sub-blocks in a portion of the indentation space. As seen to best advantage in FIG. 8C, this brace 810 does extend substantially all the way along the length of the sub-blocks, but there is still an indentation on each side of the brace 810 that separates/spaced the sub-blocks. Thus, it may be said that there are two indentations 821, 822 extending into the filter block 800 (from the bottom and the side of the filter block) along a substantial amount of the length of the sub-blocks. The reinforcement of the brace 810 helps prevent the filter block sub-blocks from snapping off or otherwise being damaged, and, because of the presence of the two indentations, said brace 810 preferably does not significantly reduce fluid access to the surfaces of the indentation. The brace 810 is preferably thin and tapered, to minimize its impact (reduction) on the indentation surface area.

FIGS. 9A-D portrays an alternative embodiment of the invented filter block 900 comprising a single cavity 911 at a first end opening into two cavities 912, 913 part way along the length of the filter block. This filter block 900 may be described as having a single filtration unit/sub-block at said first end and two sub-blocks 901, 902 an opposite end of the filter block 900, wherein the cavity 911 of the first sub-block 901 is in fluid communication with the cavities 912, 913 of the other sub-blocks 902, 903. Thus, this is one example of a branched cavity arrangement.

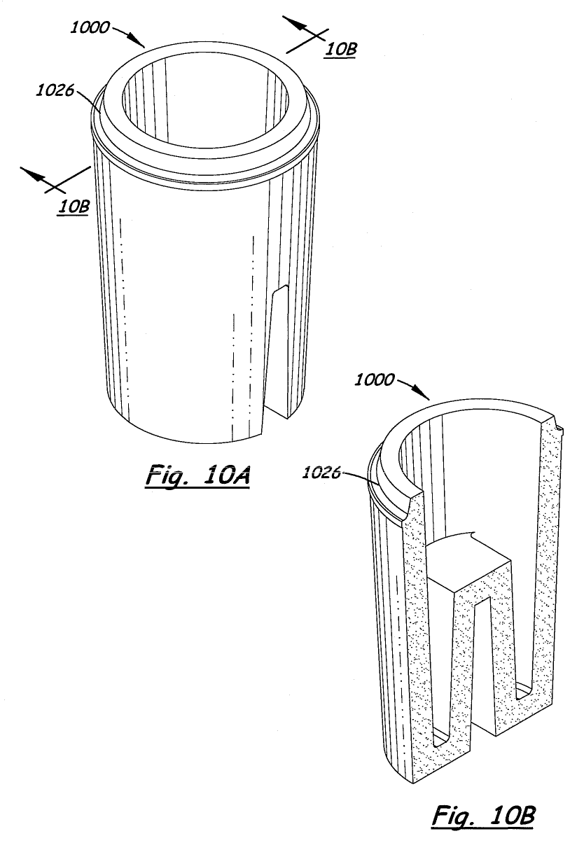

FIGS. 10A and B portray a filter block 1000 that is the same as block 900 in FIGS. 9A-D except that block 1000 has a glue depression ring 1026 around the top of the block. This depression may receive glue, or otherwise seal, to a housing or internals member for controlling fluid flow.

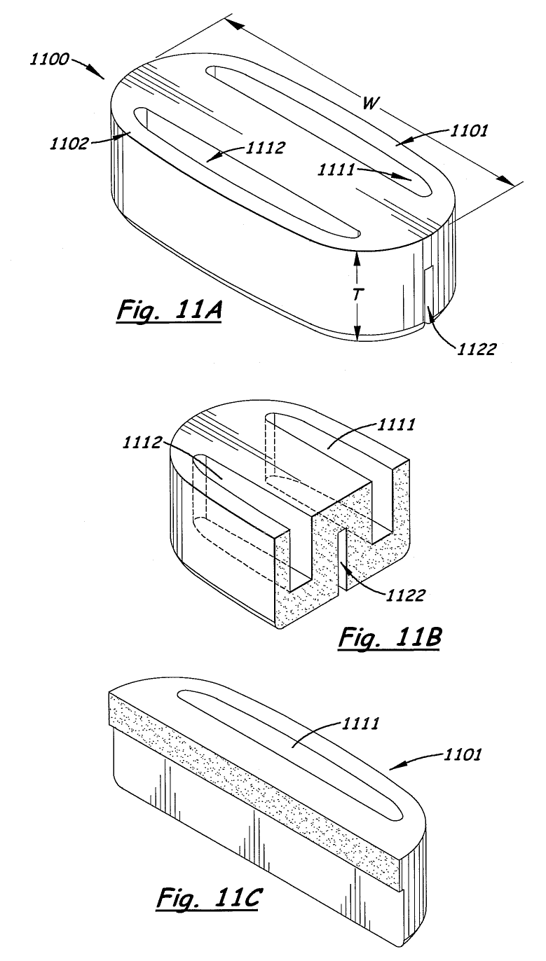

FIGS. 11A-C portray an alternative filter block 1100 for a shorter housing, wherein the filter block 1100 and its sub-blocks 1101, 1102 are wider (W) than they are tall (T). This block 1100 has two D-shaped cavities 1111, 1112 in a first end and a slot 1122 (another example of an indentation) in the second, opposing end separating portions of the two sub-blocks 1101, 1102.

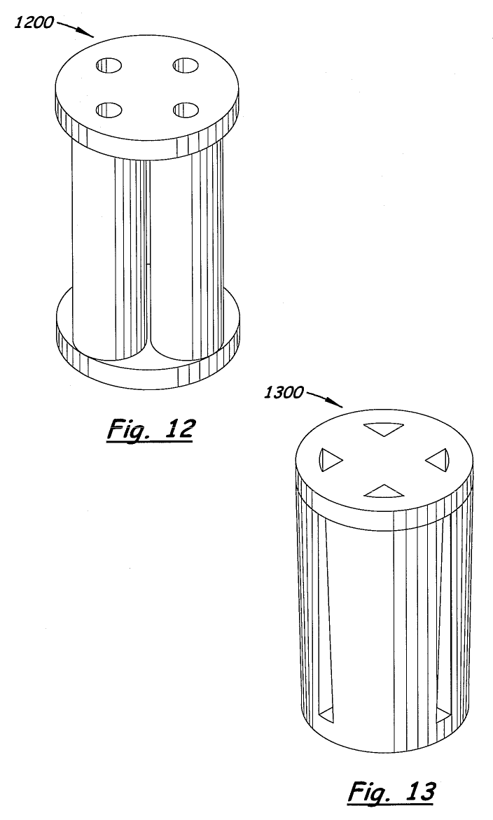

FIGS. 12A and 12B illustrates alternative embodiments 1200, 1300 of multi-core, multiple-sub-block filter blocks wherein multiple cavities are supplied to form the multiple sub-blocks, and indentations are also supplied to further separate the sub-blocks to provide additional fluid access to inner regions of the filter block. The indentations are provided in the form of gaps/spaced between the sub-blocks in regions generally midway along the length of the sub-blocks but not at the bottom of the sub-blocks. These filter blocks are some, but the only, embodiments that comprise indentations(s) that extend into the filter block at other than an end of the filter. These indentations/gaps/spaces may be described as extending into a side/sides of the filter block or extending radially into the filter block. Thus, it may be seen that, in some embodiments, indentations may extend into a central region of the filter block but not into either end of an elongated filter block. It may be noted that the bottom end of filter block 1200 comprises a solid bottom plate connecting the sub-blocks, wherein, in some embodiments there may be a seam/interface between the bottom plate and the sub-blocks comprising preferably a layer of adhesive, glue, or melted and/or re-solidified binder directly connecting the bottom plate to the sub-blocks. It may be noted that the bottom ends of the sub-blocks of filter block 1300 are preferably integrally connected with each other rather than comprising a glued or bonded seam/interface.

Many, but not all, embodiments of the multiple-sub-block sold profile filters use activated carbon and thermo-set binder, and the preferred proportions may range from about 5 up to about 70 weight percent binder, and 95 down to about 30 weight percent activated carbon plus additives. More preferably, many embodiments comprise 10-50 weight percent binder and 90 down to 50 weight percent activated carbon plus additives.

An especially preferred composition, for example, for gravity flow or low-pressure filter blocks according to embodiments of the inventions is: 30-50 wt-% binder(s), 28-52 wt-% powdered or granular activated carbon, and 18-22 wt-% lead removal media, wherein the total of the binder, activated carbon and lead removal media equals 100-%. Filter blocks, in the shape represented by FIGS. 1A-N, have been made from about 40 wt-% binder (GUR 2122™), about 38 wt-% powdered activated carbon, and about 22 wt-% lead removal (Alusil™) media. Activated carbon size distribution such as the following was used: D10 of about 10-30 microns; D50 of about 70-100 microns; and D90 of about 170-200 microns. These blocks, made in the shape of FIGS. 1A-N have been found to perform effectively in water filtration, including obtaining lead removal results that meet the recent NSF Standard 53 for lead in drinking water (less than 10 ppb lead, that is, less than 10 ppb total of soluble and particulate lead), while also achieving a flow rate of 1 liter per 4-7 minutes flow rate of water filtration. It is noteworthy that the multiple-sub-block filter block providing this excellent performance had only about a 2 inch outer diameter and about a 3 inch axial length, comprised only binder, activated carbon and lead sorbent in a solid profile, and did not contain any ion exchange resin or zeolite (which are conventionally used in gravity flow filters for metals removal). Such performance could result a filter cartridge, for a water carafe or other gravity flow apparatus, of overall dimensions of less than 3 inches in diameter and less than 5 inches in length, for example, meeting the recent NSF Standard 53 for lead removal. The inventors also believe that this performance may be achieved, with embodiments of the multiple-sub-block filters, over a long filter life.

In order to form the media components into the solid profile, a mixture of the media components and binder(s) may be placed in a mold, and may be compressed with a piston or weight on the mixture, for example, and heated to make the binder tacky enough to stick to the media particles, thus, holding them together in a solid profile when cooled. Typically, heating in a 400-500 degree F. oven for about 30 minutes will effectively heat the mixture to reach the desired amount of binder tackiness. The preferred, but optional, compression may take place before heating, during heating, and/or after heating. Compression that reduces the volume of the mixture about 10-20 percent is preferred, but this may vary and may extend to a greater range (for example, 10-40 percent) or lesser range of compression. The mixing of components may be done by various methods, with the preferred result being that the binder is interspersed between the other components for effective connection of the components in a solid profile.

Many binders may be used, for example, thermoplastic binder, thermo-set binder, polyolefins, polyethylene, polyvinyl halides, polyvinyl esters, polyvinyl ethers, polyvinyl sulfates, polyvinyl phosphates, polyvinyl amines, polyamides, polyimides, polyoxidiazoles, polytriazols, polycarbodiimides, polysulfones, polycarbonates, polyethers, polyarylene oxides, polyesters, polyarylates, phenol-formaldehyde resins, melamine-formaldehyde resins, formaldehydeureas, ethyl-vinyl acetate copolymers, co-polymers and block interpolymers thereof, and derivatives and combinations thereof.

In order to minimize the amount of carbon or carbon plus additive surface area covered/blocked by binder, preferred binders exhibit less than a 5 g/min melt index, and more preferably less than a 1 g/min melt index by ASTM D1238 or DIN 53735 at 190 degrees C. and 15 kilograms. Particularly preferred binders have a melt index (ASTM D1238 or DIN 53735 as above) of less than or equal to 0.1 g/min. Binders from these ranges, and especially from the less than 1 g/min melt index group and the less than or equal to 0.1 g/min melt index group, may be selected that become tacky enough to bind the media particles together in a solid profile, but that maintain a high percentage of the media particle surface area uncovered/unblocked and available for effective filtration. Further, the selected binders preferably leave many interstitial spaces/passages open in the solid profile; in other words, it is desirable to have the binder not completely fill the gaps between media particles. A high amount of porosity is desirable, and, when combined with the high amount of “bulk” surface area for the block (bulk surface area meaning the exposed surfaces of the block, including the cavities and preferably the indentations described above), the preferred embodiments are effective in delivering fluid to the media of the block, effective in fluid flow through the porous block, and effective in fluid flow out of the media in the block.

Embodiments of the multiple-sub-block solid profile blocks may be used in liquid filtration applications and also in air or other gaseous material filtration applications. While the filter blocks in the drawings, and the terminology used herein, are shown or described in terms of “up” and “down,” the filters are not limited to the orientations drawn; various orientations, housings, internals, and flowschemes may be used, as will be understood by one of average skill after viewing this Description and the Drawings.

While preferred examples are given above, various other sizes and types of media components may be used, and the invention is not necessarily limited to filter blocks comprising activated carbon. Alternative media may be found that, because of its porosity and/or contamination removal attributes, may be used in the multiple-sub-block shapes of the invention, as a supplement or additive to, or instead of, activated carbon. Further, there may be filtration or treatment media that may be formed in some or all of the filter block shapes of the invention that do not require binder to connect granules or powder.

Although this invention has been described above with reference to particular means, materials and embodiments, it is to be understood that the invention is not limited to these disclosed particulars, but extends instead to all equivalents within the broad scope of the following claims.

1. A solid profile filter block comprising multiple sub-blocks, each of said sub-blocks comprising filter media walls surrounding and defining a cavity for receiving fluid, and each of said sub-blocks being connected to at least one other of said sub-blocks by filter media of which the filter block is made.

2. A filter block as in claim 1 having an external surface reachable by inlet fluid to be filtered, and the filter block also having an internal surface formed by a plurality of said cavities, wherein said exterior surface comprises at least one indentation into the filter block between said cavities, so that fluid directed to the exterior surface and said at least one indentation flows through said filter media walls into said cavities and out of the filter block.

3. A filter block as in claim 1, having an internal surface defined by a plurality of said cavities in the filter block that are reachable by inlet fluid to be filtered, and the filter block also having an external surface comprising at least one indentation into the filter block between said plurality of cavities, wherein fluid directed to the internal surface flows through said filter media walls to exit the filter block at said external surface and at said at least one indentation.

4. A filter block as in claim 1, wherein the filter block is made of materials selected from the group consisting of: activated carbon powder, activated carbon granules, lead removal additive, arsenic removal additive, and one or more binders.

5. A filter block as in claim 1, comprising at least one binder having a melt index of less than or equal to 0.1 g/min melt index by ASTM D1238 or DIN 53735 at 190 degrees C. and 15 kilograms.

6. A filter block as in claim 1, wherein said sub-blocks are generally cylindrical.

7. A filter block as in claim 1, wherein said sub-blocks are generally semi-cylindrical.

8. A filter block as in claim 1, wherein said sub-blocks are generally triangular in cross-section.

9. A filter block as in claim 1, comprising only two sub-blocks.

10. A filter block as in claim 1, comprising only three sub-blocks.

11. A filter block as in claim 1, comprising only four sub-blocks.

12. A solid profile filter block comprising multiple sub-blocks, each of said sub-blocks comprising filter media walls surrounding and defining a cavity for receiving fluid, each of said sub-blocks being directly attached to at least one other of said sub-blocks by material selected from the group consisting of: adhesive, glue, and binder and combinations thereof.

13. A filter block as in claim 12, having an external surface reachable by inlet fluid to be filtered, and the filter block also having an internal surface formed by a plurality of said cavities, wherein said exterior surface comprises at least one indentation into the filter block between said cavities, so that fluid directed to the exterior surface and said at least one indentation flows through said filter media walls into said cavities and out of the filter block.

14. A filter block as in claim 12, having an internal surface defined by a plurality of said cavities in the filter block that are reachable by inlet fluid to be filtered, and the filter block also having an external surface comprising at least one indentation into the filter block between said plurality of cavities, wherein fluid directed to the internal surface flows through said filter media walls to exit the filter block at said external surface and at said at least one indentation.

15. A filter block as in claim 12, wherein the filter block is made of materials selected from the group consisting of: activated carbon powder, activated carbon granules, lead removal additive, arsenic removal additive, and one or more binders.

16. A filter block as in claim 12, comprising at least one binder having a melt index of less than or equal to 0.1 g/min melt index by ASTM D1238 or DIN 53735 at 190 degrees C. and 15 kilograms.

17. A solid profile filter block comprising a plurality of cavities in the filter block and forming internal surfaces for being in fluid communication with a fluid inlet or a fluid outlet of a filter cartridge, and the filter block comprising an external surface comprising at least one indentation extending into the filter block to be between at least two of said cavities, so that fluid flowing in an inside-out flow scheme, into said cavities and through the filter block, exits the filter block at the external surface including at said at least one indentation, and so that fluid flowing in an outside-in flow scheme, into the filter block through the external surface including the indentation, exits the filter block through said cavities.

18. A filter block as in any of claim 17, wherein said cavities extend generally parallel to each other into the filter block and said at least one indentation extends into the filter block generally parallel to the cavities.

19. A filter block as in claim 17, wherein said multiple sub-blocks are integrally formed into the filter block by molding the filter block.

20. A filter block as in claim 17, wherein said multiple sub-blocks are separately formed and directly attached together by material selected from the group consisting of: adhesive, glue, binder, and combinations thereof.

21. A filter block as in claim 17, wherein said cavities have a cross-section selected from the group consisting: circular, semi-circular, D-shaped, triangular, rectangular, and square.

22. A filter block as in claim 17, wherein the filter block has an overall outer generally shape selected from the group consisting of: cylindrical, conical, triangular, rectangular, and square.

23. A filter block as claim 17, wherein the external surface of the filter block comprises outer axial wall or walls of the filter block that are tapered so that the block has an overall smaller diameter at the bottom of the filter block compared to the top of the filter block.

24. A filter block as in claim 17, wherein the internal surface formed by said cavities are tapered so that each cavity has an overall smaller diameter at the bottom of the cavity compared to the top of the cavity.

25. A filter block as in claim 17 comprising a single cavity opening at a first end of the block, wherein said single cavities branches, farther along an axial length of the block, into multiple cavities.

26. A filter block as in claim 25, wherein the multiple cavities are closed or capped at the end opposite said single cavity.

27. A filter block as in claim 15, comprising lead removal media.

28. A method of filtering a fluid, the method comprising:
providing a solid profile filter block comprising multiple sub-blocks, each of said sub-blocks comprising filter media walls surrounding and defining a cavity for receiving fluid, and each of said sub-blocks being connected to at least one other of said sub-blocks by filter media of which the filter block is made; and
filtering said fluid by causing the fluid to flow across walls of the filter block by steps selected from the group consisting of: supplying said fluid to the cavities of the sub-blocks so that the fluid flows through said walls and collecting filtered fluid at said exterior surface of said filter block, and supplying said fluid to the external surface of the filter block so that the fluid flows through said walls and collecting filter water in said cavities.

29. A method as in claim 28, wherein said filter block further comprises external surface comprising a gap between at least a portion of each sub-block and an adjacent sub-block, and wherein said collecting filtered fluid at said exterior surface further comprises collecting filtered fluid in said gap.

30. A method as in claim 28, wherein said filter block further comprises external surface comprising a gap between at least a portion of each sub-block and an adjacent sub-block, and wherein said supplying said fluid to the external surface of the filter block further comprises supplying said fluid to said gap.

31. A method of claim 28, wherein said filtering further comprises lowering lead content in the filtered fluid to less than 10 ppb by the fluid flowing through said walls.
